(19) United States
(12) Patent Application Publication
(10) Pub. No.: US 2003/0058505 A1
(43) Pub. Date: Mar. 27, 2003

(54) Passive distribution of wavelengths in optical networks

(76) Inventors: Joseph Arol, Kiryat Ono (IL); Oren Marmur, Kiryat Ono (IL)

Correspondence Address: NIXON & VANDERHYE P.C., 8th Floor, 1100 North Glebe Rd., Arlington, VA, 22201-4714, US

(21) Appl. No.: 10/235,639

(22) Filed: Sep. 6, 2002

Related U.S. Application Data
(60) Provisional application No. 60/325,248, filed on Sep. 26, 2001.

(51) Int. Cl. H04B 10/20; H04J 14/00; H04B 10/00

(52) U.S. Cl. 359/168; 359/118

(57) ABSTRACT

An optical data network including an optical communications medium, adapted to convey optical signals of multiple different wavelengths; a plurality of optical data transceivers, which are adapted to transmit and receive the optical signals over the medium and at least one optical coupler. The optical coupler is coupled to the medium between the transceivers, and is adapted to filter the wavelengths conveyed over the medium so as to convey the optical signals in a first subset of the wavelengths only to a first group of the transceivers, and to convey the optical signals in a second subset of the wavelengths only to a second group of the transceivers, which is different from the first group.

### CROSS-REFERENCE TO RELATED APPLICATIONS

This application claims the benefit of U.S. Provisional Patent Application No. 60/325,248, filed Sep. 26, 2001, which is incorporated herein by reference.

### FIELD OF THE INVENTION

The present invention relates generally to data communication, and specifically to data transference by wavelength multiplexing of optical carriers.

### BACKGROUND OF THE INVENTION

Passive optical networks (PONs) use fibre optic cables which may be coupled together in a number of different configurations, for example, star, tree, bus, ring or mesh topologies, or combinations of these topologies. Protection against failure of a section of the network may be provided inherently, as in a ring topology, or by adding redundant fibre optic links between elements of the network.

U.S. Pat. No. 5,003,531, to Farinholt et al., whose disclosure is incorporated herein by reference, describes an optical network having all nodes of the network coupled together by fibre optic cables. The cables are configured so that a failure of a cable or of a node is overcome by protection switching to a standby link formed from the cables.

U.S. Pat. No. 5,982,517, to Fishman, whose disclosure is incorporated herein by reference, describes an optical fibre optic network comprising a plurality of synchronous optical network (SONET) rings coupled to a wavelength division multiplexing (WDM) link. The WDM link is protected against failure by rerouting WDM link traffic through a dedicated protection ring selected from the SONET rings. The rerouting is performed by “color-blind” optical fibre-to fibre switches.

U.S. Pat. No. 6,327,400, to Harstead et al., whose disclosure is incorporated herein by reference, describes a method for protecting a point-to-multipoint network against fibre and/or network terminal failure. Terminals are coupled to a ring via a 1:2 optical switch, and protection is provided in the case of a failure by switching the optical switch.

U.S. Pat. No. 6,327,400, to Dyke et al., whose disclosure is incorporated herein by reference, describes a passive optical network (PON) arrangement having a plurality of optical splitter/combiners. Each splitter/combiner comprises a pair of through ports and one or more “drop” ports which transfer a portion of radiation conveyed between the through ports to downstream optical terminals. The PON arrangement may use WDM to separate transmit and receive signals in the network.

U.S. Pat. No. 6,414,768, to Sakata et al., whose disclosure is incorporated herein by reference, describes -an optical communication system in the form of a loop network. The system utilizes an active transceiver and a standby transceiver at a head end. The pair of transceivers communicate with terminals coupled via star couplers to the loop. A test signal is transmitted in the loop to detect a fault, and when a fault is detected, a control unit at the head end operates the standby transceiver to recover communications that have been unsuccessfully transmitted because of the fault.

Bandwidth of an optical network may be increased, without changing the physical configuration of the network, by using wavelength division multiplexing. However, power budget within the network is a factor limiting the size and/or complexity of any network, whether or not WDM is used. For example, in star or tree networks using point-to-multipoint transitions, each transition significantly attenuates power transferred through the transition. In such point-to-multipoint transitions much power may be wasted, since what may actually be needed is a point-to-point transition.

Thus, a more flexible and efficient method for configuring passive optical networks is desirable.

### SUMMARY OF THE INVENTION

Preferred embodiments of the present invention seek to provide a passive optical network (PON) which is able to be configured flexibly and which is also able to significantly reduce power wastage. The network is operated in a wavelength division multiplexing (WDM) mode, and is divided topologically into autonomous regions by wavelength-dependent splitter/combiners. By dividing the network into regions, substantial sections of the network may be protected against failure within the network. Furthermore, dividing the network into regions improves power distribution within the network and increases overall bandwidth of the network.

In preferred embodiments of the present invention, an optical communications system comprises optical data transceivers, also herein termed network elements, which communicate with each other over a PON using WDM. The network elements are coupled to fibre optics within the PON, and the fibre optics are in turn coupled to wavelength-dependent splitter/combiners, herein termed couplers. The couplers act as partial separators, so that the PON is effectively split into a number of substantially independent regions, each region comprising a sub-set of the network elements present in the complete network (the PON). Network elements within each region may communicate with each other using wavelengths common to the region, but are shielded from communication with other regions which use different wavelengths. However, any network element may be a member of more than one region, depending on how the PON is configured, and also on the wavelengths that couplers connecting to the network element are configured to transmit. Thus, communication between any elements of the network may be implemented. Furthermore, by dividing the network into multiple regions, multiple paths may be formed between network elements, improving the reliability of network operation.

There is therefore provided, according to a preferred embodiment of the present invention, an optical data network including:

an optical communications medium, adapted to convey optical signals of multiple different wavelengths;

a plurality of optical data transceivers, which are adapted to transmit and receive the optical signals over the medium; and

at least one optical coupler which is coupled to the medium between the transceivers, and which is adapted to filter the wavelengths conveyed over the medium so as to convey the optical signals in a first subset of the wavelengths only to a first group of the transceivers, and to convey the optical signals in a second subset of the wavelengths only to a second group of the transceivers, which is different from the first group.

Preferably, the at least one optical coupler includes a passive optical coupler.

Further preferably, the passive optical coupler includes at least one of an element chosen from a coated beamsplitter, an un-coated beamsplitter, a diffractive optical element, a waveguide, and an optically active material.

Preferably, the passive optical coupler is operative as at least one type of filter chosen from a narrow band filter, a broad band filter, a long pass filter, and a short pass filter.

Preferably, the optical communications medium includes one or more fibre optic cables, each fibre optic cable having one or more strands.

Preferably, the optical data transceivers are configured in at least one configuration chosen from a star, tree, ring, bus, and mesh structure.

Further preferably, the first group of the transceivers and the second group of the transceivers are configured in substantially the same configuration.

Alternatively, the first group of the transceivers and the second group of the transceivers are configured in different configurations.

Preferably, the first group of the transceivers and the second group of the transceivers include at least one common transceiver.

Further preferably, the at least one common transceiver includes a head end transceiver adapted to operate as a controller of the optical signals in the first group and the second group of the transceivers.

Preferably, the first group of the transceivers is adapted to operate according to a first communication protocol, and the second group of the transceivers is adapted to operate according to a second communication protocol, different from the first protocol.

Alternatively, the first group of the transceivers and the second group of transceivers are adapted to operate according to substantially identical communication protocols.

Preferably, the at least one optical coupler includes a three port coupler having a first port which is adapted to transfer the first subset and the second subset of the wavelengths, a second port which is adapted to transfer only the first subset of the wavelengths, and a third port which is adapted to transfer only the second subset of the wavelengths.

Alternatively, the at least one optical coupler includes a three port coupler having a first and a second port which are adapted to transfer the first subset and the second subset of the wavelengths, and a third port which is adapted to transfer only the second subset of the wavelengths.

There is further provided, according to a preferred embodiment of the present invention, a method for configuring an optical data network including:

coupling a plurality of optical data transceivers to exchange optical signals of multiple different wavelengths over an optical communication medium;

coupling at least one optical coupler to the medium and the optical data transceivers; and

filtering wavelengths conveyed between the optical data transceivers using the at least one optical coupler so as to convey the optical signals in a first subset of the wavelengths only to a first group of the transceivers, and to convey the optical signals in a second subset of the wavelengths only to a second group of the transceivers, which is different from the first group.

Preferably, the at least one optical coupler includes a passive optical coupler.

Further preferably, the passive optical coupler includes at least one of an element chosen from a coated beamsplitter, an un-coated beamsplitter, a diffractive optical element, a waveguide, and an optically active material.

The method preferably also includes operating the passive optical coupler as at least one type of filter chosen from a narrow band filter, a broad band filter, a long pass filter, and a short pass filter.

Preferably, the optical communications medium includes one or more fibre optic cables, each fibre optic cable having one or more strands.

The method preferably also includes configuring the optical data transceivers in at least one configuration chosen from a star, tree, ring, bus, and mesh structure.

Preferably, configuring the optical transceivers includes configuring the first group of the transceivers and the second group of the transceivers in substantially the same configuration.

Alternatively, the first group of the transceivers and the second group of the transceivers are configured in different configurations.

Preferably, the first group of the transceivers and the second group of the transceivers include at least one common transceiver.

Further preferably, the at least one common transceiver includes a head end transceiver, and the method includes controlling the optical signals in the first group and the second group of the transceivers using the head end transceiver.

Preferably, the method includes operating the first group of the transceivers according to a first communication protocol, and operating the second group of the transceivers according to a second communication protocol, different from the first protocol.

Alternatively, the method includes operating the first group of the transceivers and the second group of transceivers according to substantially identical communication protocols.

Preferably, the at least one optical coupler includes a three port coupler having a first port which is adapted to transfer the first subset and the second subset of the wavelengths, a second port which is adapted to transfer only the first subset of the wavelengths, and a third port which is adapted to transfer only the second subset of the wavelengths.

Alternatively, the at least one optical coupler includes a three port coupler having a first and a second port which are adapted to transfer the first subset and the second subset of the wavelengths, and a third port which is adapted to transfer only the second subset of the wavelengths.

There is further provided, according to a preferred embodiment of the present invention, an optical data network for coupling a plurality of optical data transceivers to communicate, the network including:

an optical communications medium, adapted to convey optical signals of multiple different wavelengths between the transceivers; and

at least one optical coupler which is adapted to be coupled to the medium between the transceivers, and which is adapted to filter the wavelengths conveyed over the medium so as to convey the optical signals in a first subset of the wavelengths only to a first group of the transceivers, and to convey the optical signals in a second subset of the wavelengths only to a second group of the transceivers, which is different from the first group.

Preferably, the at least one optical coupler includes a passive optical coupler.

Preferably, the optical data transceivers are configured in at least one configuration chosen from a star, tree, ring, bus, and mesh structure.

Further preferably, the first group of the transceivers and the second group of the transceivers are configured in substantially the same configuration.

Alternatively, the first group of the transceivers and the second group of the transceivers are configured in different configurations.

Preferably, the first group of the transceivers is adapted to operate according to a first communication protocol, and the second group of the transceivers is adapted to operate according to a second communication protocol, different from the first protocol.

Alternatively, the first group of the transceivers and the second group of transceivers are adapted to operate according to substantially identical communication protocols.

There is further provided, according to a preferred embodiment of the present invention, a method for re-configuring an optical data network having a plurality of optical data transceivers coupled to exchange optical signals of multiple different wavelengths over an optical communication medium, the method including:

retro-fitting at least one optical coupler to the medium and the optical data transceivers; and

filtering wavelengths conveyed between the optical data transceivers using the at least one optical coupler so as to convey the optical signals in a first subset of the wavelengths only to a first group of the transceivers, and to convey the optical signals in a second subset of the wavelengths only to a second group of the transceivers, which is different from the first group.

Preferably, the at least one optical coupler includes a wavelength dependent passive optical coupler, wherein the optical network initially includes a wavelength independent coupler, and wherein retro-fitting the at least one optical coupler includes replacing the wavelength independent coupler with the wavelength dependent passive optical coupler.

Preferably, the at least one optical coupler includes a passive wavelength dependent optical coupler, wherein the optical network initially includes an active wavelength dependent coupler, and wherein retro-fitting the at least one optical coupler includes replacing the active wavelength dependent coupler with the passive wavelength dependent optical coupler.

Preferably, the optical data network initially operates according to a first protocol, and retro-fitting the at least one optical coupler includes replacing the first protocol by a second protocol, different from the first protocol.

The present invention will be more fully understood from the following detailed description of the preferred embodiments thereof, taken together with the drawings, in which:

### BRIEF DESCRIPTION OF THE DRAWINGS

FIG. 1 is a schematic diagram of a passive optical network (PON), according to a preferred embodiment of the present invention; and

FIG. 2 is a schematic diagram illustrating properties of wavelength dependent couplers used in the PON of FIG. 1, according to a preferred embodiment of the present invention.

### DETAILED DESCRIPTION OF PREFERRED EMBODIMENTS

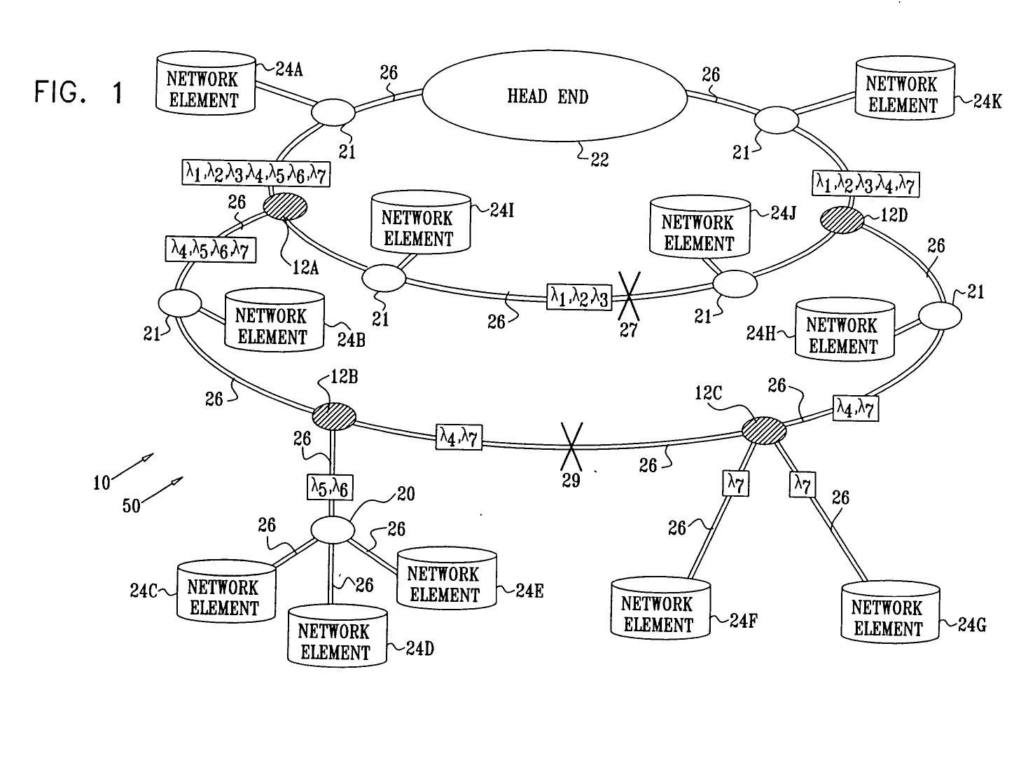

Reference is now made to FIG. 1, which is a schematic diagram of a passive optical network (PON) 10, according to a preferred embodiment of the present invention. Network 10 comprises generally similar optical data transceivers 24A, 24B, . . . , 24J, and 24K, herein also termed network elements, and generically termed network elements (NEs) 24. Network 10 also comprises a head end element 22, which is able to transmit data to and receive data from network elements 24, and which acts as a controller of the network. Network elements 24 are coupled to each other by fibre optic cables 26, and head end element 22 is also coupled to network elements 24A and 24K by cables 26. Network elements 24A, 24I, 24J, 24K, 24B, and 24H are coupled to their respective fibre optic cables 26 by respective wavelength independent splitters 21. Network elements 24C, 24D, 24E, 24F, and 24G act as terminators of their respective fibre optic cables 26. Cables 26 comprise one or more fibre optic strands, each fibre optic strand being able to convey optical radiation within the strand. Each cable 26 may comprise two strands which are used to convey optical radiation in opposite directions. Alternatively, a single fibre optic strand may be used to convey bi-directional radiation.

Elements 24 and head element 22 transfer data between themselves by using optical radiation as a data carrier. The optical radiation is wavelength multiplexed, and by way of example head end element 22 is assumed to operate at seven different wavelengths λ₁, λ₂, λ₃, λ₄, λ₅, λ₆, and λ₇, herein generically termed wavelengths λ. Each wavelength λ may be substantially a single wavelength, or alternatively may comprise a group of two or more wavelengths. For example, λ₁ may comprise 1510 nm and 1530 nm, which are typically used as separate receive and transmit carriers.

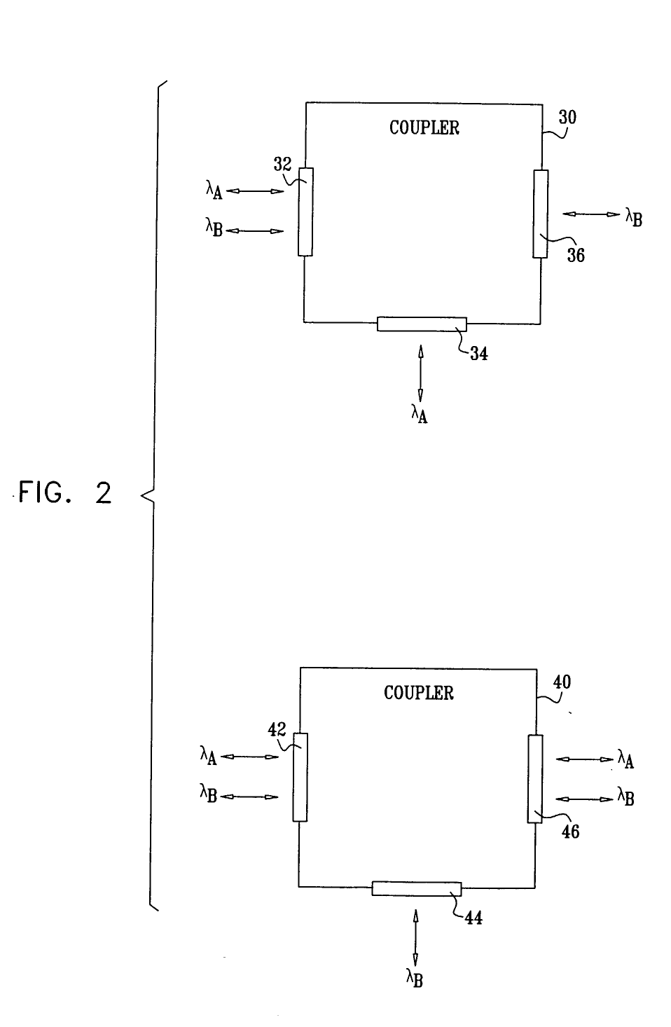

Network 10 comprises passive wavelength dependent couplers 12A, 12B, 12C, and 12D, herein also generically termed couplers 12, which transfer optical radiation between fibre optic cables 26 to which they are connected, and which are wavelength dependent. Couplers 12 comprise three or more ports connecting to the fibre optic cables, and act as wavelength dependent splitter/combiners of optical radiation. Examples of couplers 12 and their operation are described with reference to FIG. 2 below. Network 10 also, by way of example, comprises a wavelength independent one-to-many star splitter 20.

FIG. 2 is a schematic diagram illustrating properties of passive wavelength dependent couplers, according to a preferred embodiment of the present invention. A first coupler 30 comprises three optical ports 32, 34, and 36, also referred to herein as ports A, B, and C respectively. Each port 32, 34, and 36 may operate as a unidirectional port or as a bi-directional port. Port 32 receives radiation having two wavelengths λ_{A} and λ_{B}, and coupler 30 divides the radiation so that substantially all energy at wavelength λ_{A} is radiated from port 34 and substantially all energy at wavelength λ_{B} is radiated from port 36. Coupler 30 may also operate as a combiner of wavelengths λ_{A}, and λ_{B}. For example, port 34 receives wavelength λ_{A} and port 36 receives wavelength λ_{B}, and substantially all energy at wavelengths λ_{A} and λ_{B} is radiated from port 32.

A second coupler 40 comprises three optical ports 42, 44, and 46, also referred to herein as ports D, E, and F respectively. Each port 42, 44, and 46 may operate as a unidirectional port or as a bi-directional port. Port 42 receives radiation having two wavelengths λ_{A}, and λ_{B}. Coupler 40 divides the radiation so that substantially all energy at wavelength λ_{A} is transferred from port 42 to port 46 and is radiated therefrom. Energy at wavelength λ_{B} is split so that a first portion is conveyed to port 44, and a second, remaining, portion is conveyed to port 46. Typically the first portion is a small percentage of the total energy incident at port 42. A similar process occurs for radiation at wavelengths λ_{A} and λ_{B} initially incident on port 46, substantially all energy at λ_{A} being conveyed to port 42, and a portion of the energy at λ_{B} being diverted to port 44. Energy incident on port 44, at wavelength λ_{B}, may be transferred to port 42, port 46, or both ports, depending how coupler 40 is configured. (It will be appreciated that coupler 40 may be implemented as a combination of coupler 30 with a splitter.) Herein it is assumed that energy at λ_{B} incident on port 44 is transferred to both ports 42 and 46.

Those skilled in the optical art will be familiar with other types of passive wavelength dependent couplers, similar in operation to that described above for couplers 30 and 40, and methods for implementing such couplers. The passive couplers may be formed by combining one or more couplers of the form of coupler 30 and/or coupler 40, and may comprise wavelength-dependent optical elements such as coated or un-coated beamsplitters, diffractive optical elements, waveguide elements and/or an optically active material such as a ferroelectric, or combinations or sub-combinations of such elements. Each such coupler may be formed as a narrow or a broad band filter, and/or as a long or short pass filter, or as a combination of these types of filters, according to wavelength transmission and reflection requirements of the coupler being implemented. All such types of passive couplers are assumed to be within the scope of the present invention.

Returning to FIG. 1, couplers 12A, 12B, and 12D are implemented to operate as three port wavelength dependent couplers similar to coupler 30. Table I below shows characteristics of each of these couplers.

TABLE I

| | Ports, elements coupled to ports, and | | |
|---|---|---|---|
| | wavelengths transferred via ports. | | |
| Coupler | Port A | Port B | Port C |
| 12A | NE 24A | NE 24B | NE 24I |
| | λ₁, λ₂, λ₃, | λ₄, λ₅, λ₆, | λ₁, λ₂, and |
| | λ₄, λ₅, λ₆, | and λ₇ | λ₃ |
| | and λ₇ | | |
| 12B | NE 24B | Splitter 20 | Coupler 12C |
| | λ₄, λ₅, λ₆, | λ₅ and λ₆ | λ₄ and λ₇ |
| | and λ₇ | | |
| 12D | NE 24K | NE 24J | NE 24H |
| | λ₁, λ₂, λ₃, | λ₁, λ₂, and | λ₄ and λ₇ |
| | λ₄, and λ₇ | λ₃ | |

Coupler 12C is implemented to operate as a three port wavelength dependent coupler similar to coupler 40. Table II below shows characteristics of coupler 12C.

TABLE II

| | Ports, elements coupled to ports, and | | |
|---|---|---|---|
| | wavelengths transferred via ports. | | |
| Coupler | Port D | Port E | Port F |
| 12C | Coupler 12B | NE 24F, NE 24G | NE 24H |
| | λ₄ and λ₇ | λ₇ | λ₄ and λ₇ |

Most preferably, each NE 24 comprises a respective filter which only allows wavelengths transferred to and from the network element to pass. For example, NE 24H comprises a filter allowing wavelengths λ₄ and λ₇ to be received by and transmitted from the network element.

It will be appreciated by inspection of FIG. 1 that couplers 12 divide network 10 into topologically distinct regions, the network elements within each region being able to communicate with each other using one or more wavelengths transmitted within each region. Because the regions are topologically distinct, communications within each region may be performed substantially independently of and in parallel with communications within other regions. Table III below shows regions A, B, C, and D of network 10, network elements within each region, and wavelengths used for transferring data within each region.

TABLE III

| | | Wavelengths used to |
|---|---|---|
| | Network Elements comprised | transmit data within |
| Region | within the region | the region |
| A | Head end 22, NEs 24A, 24I, | λ₁, λ₂, and λ₃ |
| | 24J, and 24K | |
| B | Head end 22, NEs 23A, 24B, | λ₇ |
| | 24F, 24G, 24H, and 24K | |
| C | Head end 22, NEs 24A, 24B, | λ₅ and λ₆ |
| | 24C, 24D, and 24E | |
| D | Head end 22, NEs 24A, 24B, | λ₄ |
| | 24H, and 24K | |

The regions defined by couplers 12 may comprise star, tree, ring, bus, or mesh structures, or combinations of these or other topological structures. Each region functions according to properties specific to the region, substantially independent of properties of other regions within network 10. For example, region C described above comprises point-to-multipoint star coupler 20, so that network elements 24C, 24D, and 24E may act as downstream optical network units which are controlled by head end 22 operating as an upstream unit. Since elements 24C, 24D, and 24E are coupled by coupler 20 and operate at the same wavelengths λ₅ and λ₆, head end 22 most preferably controls their operation by one of the time division multiplexed (TDM) systems known in the art, in order to prevent data information collisions within the third region.

Depending on the type of structure defined, a region may include prevention against a failure within the region. For example, region A described above comprises a ring structure which may be implemented to operate as a token ring. A failure within the ring, for example, a break in cable 26 between network elements 24I and 24J, at a point 27, does not destroy the connectivity between head end 22 and network elements 24A, 24I 24J, and 24K. Similarly, a failure within one specific region of the network may have substantially no effect on connectivity of other regions. For example, the failure at point 27 has substantially no effect on communications within region B described above. Conversely, a failure at a point 29 between couplers 12B and 12C in region B has substantially no effect on communications within region A.

Network 10 uses head end 22 as an overall controller of the network, and head end 22 and network element 24A are members of all regions of the network. However, it will be appreciated that there is no necessity for there to be one or more network elements which are common to all regions of networks configured within the scope of the present invention. For example, a network 50 may be configured to be substantially the same as network 10, but without head end 22, network element 24A, and their interconnecting cable 26. Table IV below shows regions E, F, G, and H of network 50, elements within the regions, and wavelengths used by the regions.

TABLE IV

| | | Wavelengths used to |
|---|---|---|
| | Network Elements comprised | transmit data within |
| Region | within the region | the region |
| E | NEs 24I, 24J, and 24K | λ₁, λ₂, and λ₃ |
| F | NEs 24B, 24F, 24G, 24H, and | λ₇ |
| | 24K | |
| G | NEs 24B, 24C, 24D, and 24E | λ₅ and λ₆ |
| H | NEs 24B, 24H, and 24K | λ₄ |

By inspection of Table IV it will be observed that there is no common network element to regions comprising network 50. Communications within each region in network 50 may be controlled by a network element in each respective region which is designated to be a region controller.

Networks such as network 10 and network 50 have significantly better utilization of power compared to networks which are not divided into regions. For example, referring to Table III, power in region A is divided between head end 22 and four network elements 24A, 24I, 24J, and 24K, and is not radiated to other elements of network 10, wherein the power would be wasted. Similar power savings occur for other regions of both networks 10 and 50.

It will be appreciated that each region that a network such as network 10 is sub-divided into may operate with a different protocol, unrelated to that operated by any other region. For example, region A may operate using an asynchronous time multiplexed PON (APON) protocol, region B may operate using a carrier sense multiple access with collision detection (CSMA/CD) protocol such as an Ethernet PON (EPON) protocol, region C may operate using a time division multiple access (TDMA) protocol such as a gigabit PON (GPON) protocol, and region D may operate according to any other standard or custom protocol implemented by an operator of the network. Alternatively, since the regions are substantially independent, two or more regions may operate using the same protocol.

It will also be appreciated that networks such as networks 10 or 50 may be implemented by retro-fitting couplers such as couplers 12to existing networks. The retro-fitting preferably replaces couplers which are operative as substantially wavelength independent couplers with wavelength dependent couplers such as couplers 12. Alternatively, the retro-fitting may take the form of adding couplers such as couplers 12 to an existing network. Furthermore, couplers such as couplers 12 may be retro-fitted to networks having active couplers, such as optical add/drop multiplexers (OADMs); in this case a protocol initially operating the network may need to be altered and/or replaced to accommodate the change from an active coupler to a passive coupler. Thus, a network which is initially undivided may be re-configured into regions, defined by couplers 12, which comprise sub-sets of network elements of the original network.

It will thus be appreciated that the preferred embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. An optical data network comprising:
an optical communications medium, adapted to convey optical signals of multiple different wavelengths;
a plurality of optical data transceivers, which are adapted to transmit and receive the optical signals over the medium; and
at least one optical coupler which is coupled to the medium between the transceivers, and which is adapted to filter the wavelengths conveyed over the medium so as to convey the optical signals in a first subset of the wavelengths only to a first group of the transceivers, and to convey the optical signals in a second subset of the wavelengths only to a second group of the transceivers, which is different from the first group.

2. A network according to claim 1, wherein the at least one optical coupler comprises a passive optical coupler.

3. A network according to claim 2, wherein the passive optical coupler comprises at least one of an element chosen from a coated beamsplitter, an un-coated beamsplitter, a diffractive optical element, a waveguide, and an optically active material.

4. A network according to claim 2, wherein the passive optical coupler is operative as at least one type of filter chosen from a narrow band filter, a broad band filter, a long pass filter, and a short pass filter.

5. A network according to claim 1, wherein the optical communications medium comprises one or more fibre optic cables, each fibre optic cable having one or more strands.

6. A network according to claim 1, wherein the optical data transceivers are configured in at least one configuration chosen from a star, tree, ring, bus, and mesh structure.

7. A network according to claim 6, wherein the first group of the transceivers and the second group of the transceivers are configured in substantially the same configuration.

8. A network according to claim 6, wherein the first group of the transceivers and the second group of the transceivers are configured in different configurations.

9. A network according to claim 1, wherein the first group of the transceivers and the second group of the transceivers comprise at least one common transceiver.

10. A network according to claim 9, wherein the at least one common transceiver comprises a head end transceiver adapted to operate as a controller of the optical signals in the first group and the second group of the transceivers.

11. A network according to claim 1, wherein the first group of the transceivers is adapted to operate according to a first communication protocol, and the second group of the transceivers is adapted to operate according to a second communication protocol, different from the first protocol.

12. A network according to claim 1, wherein the first group of the transceivers and the second group of transceivers are adapted to operate according to substantially identical communication protocols.

13. A network according to claim 1, wherein the at least one optical coupler comprises a three port coupler comprising a first port which is adapted to transfer the first subset and the second subset of the wavelengths, a second port which is adapted to transfer only the first subset of the wavelengths, and a third port which is adapted to transfer only the second subset of the wavelengths.

14. A network according to claim 1, wherein the at least one optical coupler comprises a three port coupler comprising a first and a second port which are adapted to transfer the first subset and the second subset of the wavelengths, and a third port which is adapted to transfer only the second subset of the wavelengths.

15. A method for configuring an optical data network comprising:
coupling a plurality of optical data transceivers to exchange optical signals of multiple different wavelengths over an optical communication medium;
coupling at least one optical coupler to the medium and the optical data transceivers; and
filtering wavelengths conveyed between the optical data transceivers using the at least one optical coupler so as to convey the optical signals in a first subset of the wavelengths only to a first group of the transceivers, and to convey the optical signals in a second subset of the wavelengths only to a second group of the transceivers, which is different from the first group.

16. A method according to claim 15, wherein the at least one optical coupler comprises a passive-optical coupler.

17. A method according to claim 16, wherein the passive optical coupler comprises at least one of an element chosen from a coated beamsplitter, an uncoated beamsplitter, a diffractive optical element, a waveguide, and an optically active material.

18. A method according to claim 16, and comprising operating the passive optical coupler as at least one type of filter chosen from a narrow band filter, a broad band filter, a long pass filter, and a short pass filter.

19. A method according to claim 15, wherein the optical communications medium comprises one or more fibre optic cables, each fibre optic cable having one or more strands.

20. A method according to claim 15, and comprising configuring the optical data transceivers in at least one configuration chosen from a star, tree, ring, bus, and mesh structure.

21. A method according to claim 20, wherein configuring the optical transceivers comprises configuring the first group of the transceivers and the second group of the transceivers in substantially the same configuration.

22. A network according to claim 6, wherein the first group of the transceivers and the second group of the transceivers are configured in different configurations.

23. A method according to claim 15, wherein the first group of the transceivers and the second group of the transceivers comprise at least one common transceiver.

24. A method according to claim 23, wherein the at least one common transceiver comprises a head end transceiver, and comprising controlling the optical signals in the first group and the second group of the transceivers using the head end transceiver.

25. A method according to claim 15, and comprising operating the first group of the transceivers according to a first communication protocol, and operating the second group of the transceivers according to a second communication protocol, different from the first protocol.

26. A method according to claim 15, and comprising operating the first group of the transceivers and the second group of transceivers according to substantially identical communication protocols.

27. A method according to claim 15, wherein the at least one optical coupler comprises a three port coupler comprising a first port which is adapted to transfer the first subset and the second subset of the wavelengths, a second port which is adapted to transfer only the first subset of the wavelengths, and a third port which is adapted to transfer only the second subset of the wavelengths.

28. A method according to claim 15, wherein the at least one optical coupler comprises a three port coupler comprising a first and a second port which are adapted to transfer the first subset and the second subset of the wavelengths, and a third port which is adapted to transfer only the second subset of the wavelengths.

29. An optical data network for coupling a plurality of optical data transceivers to communicate, the network comprising:
an optical communications medium, adapted to convey optical signals of multiple different wavelengths between the transceivers; and
at least one optical coupler which is adapted to be coupled to the medium between the transceivers, and which is adapted to filter the wavelengths conveyed over the medium so as to convey the optical signals in a first subset of the wavelengths only to a first group of the transceivers, and to convey the optical signals in a second subset of the wavelengths only to a second group of the transceivers, which is different from the first group.

30. A network according to claim 29, wherein the at least one optical coupler comprises a passive optical coupler.

31. A network according to claim 29, wherein the optical data transceivers are configured in at least one configuration chosen from a star, tree, ring, bus, and mesh structure.

32. A network according to claim 31, wherein the first group of the transceivers and the second group of the transceivers are configured in substantially the same configuration.

33. A network according to claim 31, wherein the first group of the transceivers and the second group of the transceivers are configured in different configurations.

34. A network according to claim 29, wherein the first group of the transceivers is adapted to operate according to a first communication protocol, and the second group of the transceivers is adapted to operate according to a second communication protocol, different from the first protocol.

35. A network according to claim 29, wherein the first group of the transceivers and the second group of transceivers are adapted to operate according to a common communication protocol.

36. A method for re-configuring an optical data network comprising a plurality of optical data transceivers coupled to exchange optical signals of multiple different wavelengths over an optical communication medium, the method comprising:
retro-fitting at least one optical coupler to the medium and the optical data transceivers; and
filtering wavelengths conveyed between the optical data transceivers using the at least one optical coupler so as to convey the optical signals in a first subset of the wavelengths only to a first group of the transceivers, and to convey the optical signals in a second subset of the wavelengths only to a second group of the transceivers, which is different from the first group.

37. A method according to claim 36, wherein the at least one optical coupler comprises a wavelength dependent passive optical coupler, wherein the optical network initially comprises a wavelength independent coupler, and wherein retro-fitting the at least one optical coupler comprises replacing the wavelength independent coupler with the wavelength dependent passive optical coupler.

38. A method according to claim 36, wherein the at least one optical coupler comprises a passive wavelength dependent optical coupler, wherein the optical network initially comprises an active wavelength dependent coupler, and wherein retro-fitting the at least one optical coupler comprises replacing the active wavelength dependent coupler with the passive wavelength dependent optical coupler.

39. A method according to claim 38, wherein the optical data network initially operates according to a first protocol, and wherein retro-fitting the at least one optical coupler comprises replacing the first protocol by a second protocol, different from the first protocol.
